(19) United States
(12) Patent Application Publication
(10) Pub. No.: US 2018/0232637 A1
(43) Pub. Date: Aug. 16, 2018

(54) MACHINE LEARNING METHOD FOR OPTIMIZING SENSOR QUANTIZATION BOUNDARIES

(71) Applicant: PHILIPS LIGHTING HOLDING B.V., EINDHOVEN (NL)

(72) Inventors: DAVID RICARDO CAICEDO FERNANDEZ, EINDHOVEN (NL); ASHISH VIJAY PANDHARIPANDE, EINDHOVEN (NL)

(21) Appl. No.: 15/890,912

(22) Filed: Feb. 7, 2018

(30) Foreign Application Priority Data
Feb. 14, 2017 (EP) 17156023.8

(51) Int. Cl. G06N 3/08; G06N 3/04

(52) U.S. Cl. CPC G06N 3/08; G06N 3/0481

(57) ABSTRACT

A computer-implemented method of optimizing non-uniform quantization boundaries for a quantization unit of a sensor is provided. The method comprises:
obtaining a digital representation of a model (120) for predicting the target metric (124) from an unquantized sensor signal (122), the model being defined by at least the quantization boundaries, the model comprising:
   a first layer (130) of multiple continuous quantization functions (142, 144, 146; ƒ₁, . . . , ƒ_{Q}), the quantization functions approximating block functions on quantization intervals defined by the quantization boundaries and receiving as input an unquantized sensor signal, and
   a second layer (132) comprising a function taking as input the output of the multiple continuous quantization functions and generating as output a prediction of the target metric, and
training (530) the model using the training data by iteratively updating (126) the quantization boundaries.

### FIELD OF THE INVENTION

The invention relates to a computer-implemented method of optimizing non-uniform quantization boundaries for a quantization unit of a sensor, a quantization boundary optimization device for a quantization unit of a sensor, a system for predicting a target metric, an electronic method for predicting a target metric, and a computer readable medium.

### BACKGROUND

Smart lighting systems with multiple luminaires and sensors are witnessing a steady growth. Such systems may use multi-modal sensor inputs, e.g., in the form of occupancy and light measurements, to control the light output of the luminaires and adapt artificial lighting conditions to prevalent environmental conditions. With the spatial granularity that such a sensor deployment comes in the context of lighting systems, there is potential to use sensor data to learn about the operating environment. One such aspect is related to occupancy. There is increased interest in learning about the occupancy environment beyond basic presence. For example, occupancy modeling is closely related to building energy efficiency, lighting control, security monitoring, emergency evacuation, and rescue operations. In some applications, occupancy modeling may be used in making automatic decisions, e.g., on HVAC control, etc.

Advanced sensor technologies like cameras may be used for this purpose. However, there is increased cost in this approach.

A known solution is proposed in the paper “Cross-Space Building Occupancy Modeling by Contextual Information Based Learning”, by Zheng Yang and Burcin Becerik-Gerber (included by reference). The known solution takes various input features, including binary presence detectors such as PIR sensors and provide them to a supervised machine learning algorithm. The supervised machine learning algorithm builds a general relationship model between classes of occupancy and the input features. The paper compares five different types of machine learning algorithms: Support Vector Machine (SVM), Naïve Bayesian (NB), Tree Augmented Naive Bayesian (TAN), Artificial Neural Network (ANN), and Random Forest (RF).

There are disadvantages to the known system. When occupancy modelling is done using a centralized trained network, all sensors need to report their sensor data to a central computer. If the number of sensors is larger, and/or the sensor frequency is large this uses up part of the bandwidth of the network. Data reduction techniques may inadvertently throw away information that is important to the back-end prediction process. Especially in machine learning it is difficult to tell which aspect of a signal will prove to be important to a machine learned algorithm. Moreover, there is a trade-off between the amount of data to be transmitted from each PIR occupancy sensor and the accuracy of the people count.

### SUMMARY OF THE INVENTION

A computer-implemented method of optimizing non-uniform quantization boundaries for a quantization unit of a sensor is provided. The method comprises:

obtaining training data comprising multiple unquantized sensor signals and multiple corresponding target metrics, the sensor data being obtained from one or more sensors,

obtaining a digital representation of a model for predicting the target metric from an unquantized sensor signal, the model being defined by at least the quantization boundaries, the model comprising:
a first layer of multiple continuous quantization functions, the quantization functions approximating block functions on quantization intervals defined by the quantization boundaries and receiving as input an unquantized sensor signal, and
a second layer comprising a function taking as input the output of the multiple continuous quantization functions and generating as output a prediction of the target metric, and

training the model using the training data by iteratively updating the quantization boundaries,

configuring a quantization unit of a sensor with quantization boundaries obtained from the trained model, the quantization unit being arranged to select in which quantization interval, defined by the quantization boundaries, a sensor signal falls and to quantize the sensor signal by a representation of the selected interval.

By replacing quantization boundaries with quantization functions during training, machine learning algorithms can be made to include the training of the quantization boundaries. The method thus presents a way to train quantization boundaries using machine learning. Even though continuous quantization functions are used during training, only the final quantization boundaries are configured in a sensor, so that the quantization functions are not needed after training. Using quantized signals instead of sending the raw signal during the operational phase reduces network overhead. On the other hand, the machine learning algorithm had the opportunity to select itself which parts of the sensor signal it deemed important.

A further aspect of the invention is a quantization boundary optimization device for a quantization unit of a sensor. Furthermore, a system for predicting a target metric and a method for predicting a target metric are presented. The prediction system is improved since it uses optimized quantization boundaries.

The training device, prediction device and sensor are electronic devices. The method of training quantization intervals and the method of predicting a target metric described herein may be applied in a wide range of practical applications. One particular application that is focused upon here is the prediction of occupancy metrics from occupancy sensors, in particular PIR sensors.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

Another aspect of the invention provides a method of making the computer program available for downloading. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1 schematically shows an example of an embodiment of a quantization boundary optimization system,

FIG. 2 schematically shows an example of an embodiment of a system for predicting a target metric,

FIG. 3 schematically shows an example of an embodiment of multiple continuous quantization functions,

FIG. 4a-4c schematically show examples of an embodiment of multiple continuous quantization functions,

FIG. 5a schematically shows an example of an embodiment of a computer-implemented method of optimizing non-uniform quantization boundaries for a quantization unit of a sensor,

FIG. 5b schematically shows an example of an embodiment of an electronic method for predicting a target metric,

FIG. 6 schematically shows an example of an embodiment of an office,

FIG. 7a schematically shows a computer readable medium having a writable part comprising a computer program according to an embodiment,

FIG. 7b schematically shows a representation of a processor system according to an embodiment.

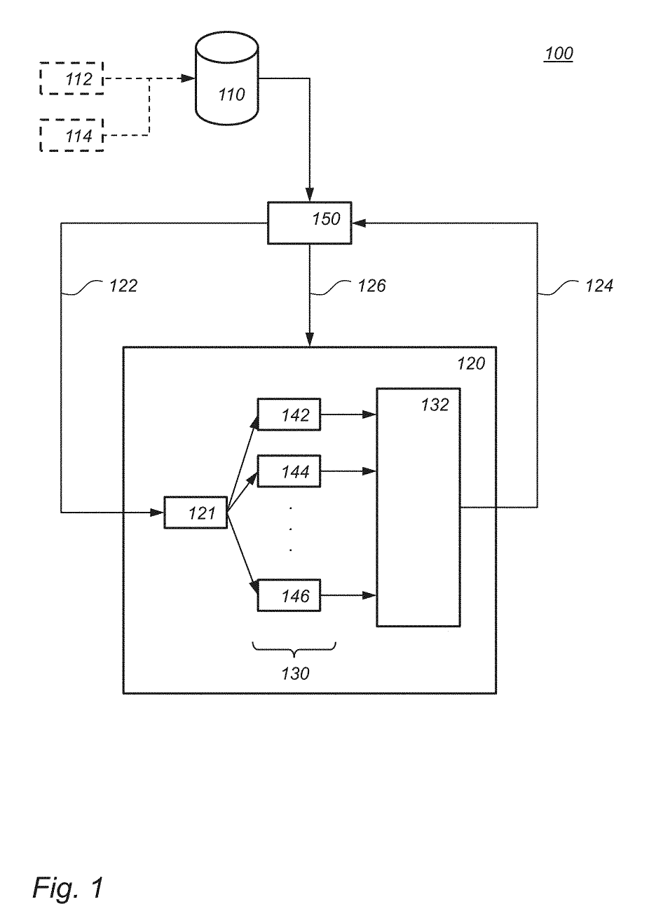

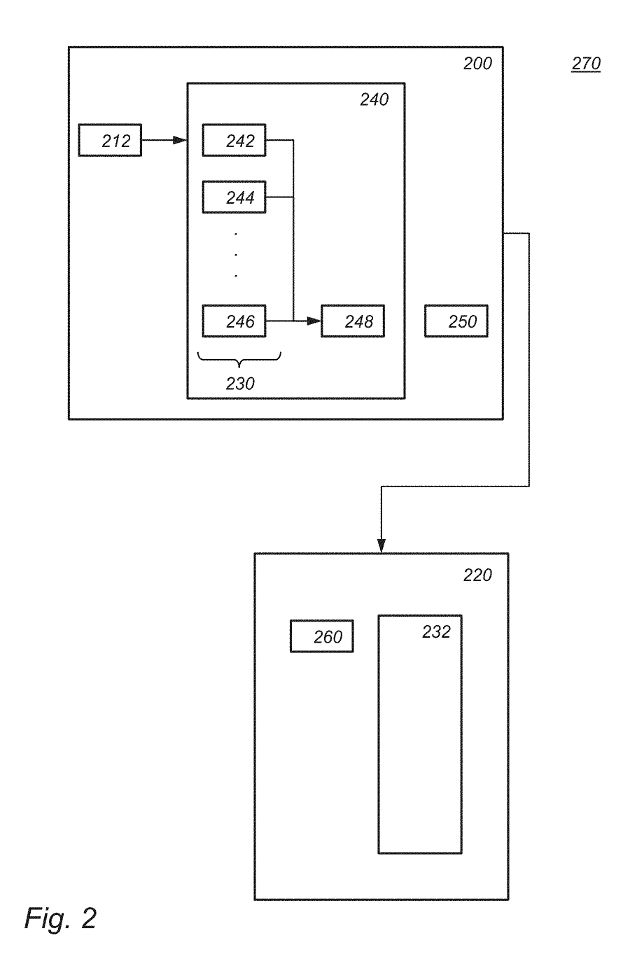

### LIST OF REFERENCE NUMERALS IN FIG. 1-2

100 a quantization boundary optimization system
110 a training data storage
112 a sensor
114 a target metric input
120 a model
121 a model input
122 an unquantized sensor signal
124 a prediction of a target metric
126 an update signal of quantization boundaries,
130 a first layer of multiple continuous quantization functions
132 a second layer
142-146 quantization functions
150 a quantization boundary optimization device
200 a sensor
212 sensing unit
220 a prediction device
230 a first layer of quantization intervals
232 a second layer
240 a quantization unit
242-246 a quantization boundary
248 an encoder
250 a transmitter
260 an input
270 a system for predicting a target metric

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

FIG. 1 schematically shows an example of an embodiment of a quantization boundary optimization system 100. System 100 optimizes the non-uniform quantization boundaries for a quantization unit of a sensor. A quantization unit maps a continuous variable to one of multiple discrete values. The quantization reduces the amount of data that needs to be transmitted or stored. The quantization unit contains a number of quantization intervals, separated by quantization boundaries, e.g., real numbers. The quantization intervals are consecutive. The highest and lowest quantization intervals may be open intervals, running up and/or down to plus or minus infinity respectively. This is not necessary though, any one or both of the highest and lowest quantization intervals may be a finite interval. The quantization unit determines in which quantization interval a variable, e.g., a sensor value falls. An encoding of this interval is then taken as the quantization of the variable.

In uniform quantization bounds, each quantization interval has the same size. However, in non-uniform quantization bounds not all quantization intervals have the same size. This leads to the problem, how to choose the quantization bounds. Preferably, the bounds are chosen so that the amount of information lost due to the quantization is minimal, especially in light of the activity for which the quantized data is needed. The system 100 finds quantization bounds that are optimized to reduce the information lost for a specific prediction task, e.g., to predict some target metric. It is not immediately clear how the quantization bounds are to be optimized, especially if the model contains additional parameters beyond the quantization bounds that need optimizing. In any case, optimizing the quantization bounds is a hard optimization problem.

As an example, the system and method may be applied to predict an occupancy metric, e.g., a people count or a people density. Obtaining estimates of the number of people using an office space, a building and the like, has numerous applications. For example, the estimates may be used to verify if the building is utilized correctly, e.g., not overcrowded or under populated. Occupancy metric may also be used to verify if safety regulations are met. Occupancy metrics may be restricted to the number or density of sitting people. Counting the number of sitting people is especially important, as people who are only moving through a room do not add to the use of an office space, and may often be ignored. The excitation pattern on a sensor of sitting versus standing or moving people is quite different. The movement in sitting people is generally smaller. A sensor that is optimized for sitting people occupancy metric will likely have more and/or finer quantization intervals at the range where sitting people activate the sensor; in this way, the second layer 132 can see the difference between a sitting person and an empty desk.

Conventionally counting people has been based on using advanced sensor technologies like cameras. While reliable, these technologies are expensive and their use may be undesired due to privacy concerns. Binary occupancy sensors have been used, e.g., in lighting systems, but even a network of such sensors cannot easily be used for obtaining a people count. We optimize the quantization in sensor to work better with trained or fixed back-end prediction systems.

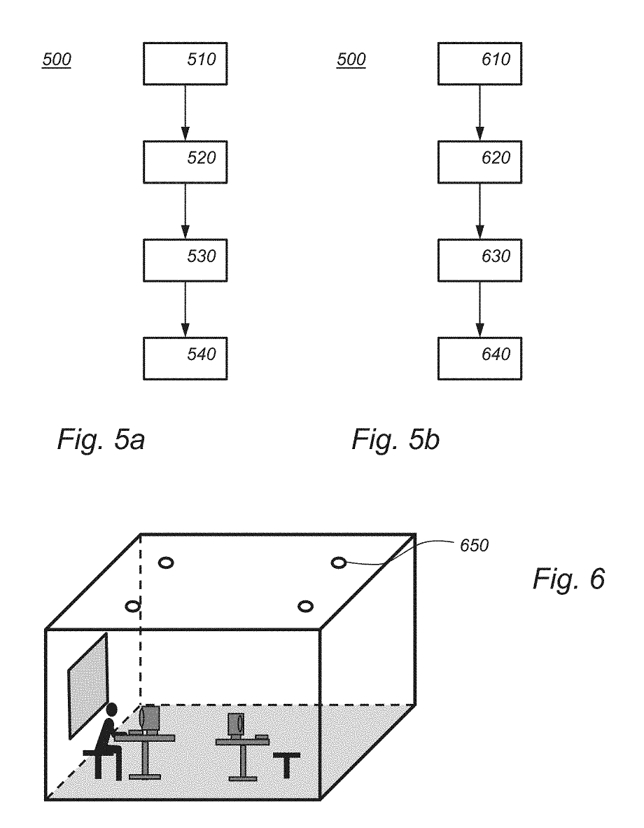

For example, the sensors may be passive infrared (PIR) sensors. Interestingly, such sensors are increasingly available in buildings as they are also used as part of connected lighting networks. Consider FIG. 6. FIG. 6 schematically shows an example of an embodiment of an office. FIG. 6 shows an office in which PIR sensors 650 are installed. Four sensors are shown in FIG. 6. Note that in FIG. 6 the sensors cover an overlapping area. Each of the sensors covers some area that is not covered by all of the other sensors. The inventors found that deriving occupancy information is easier if sensor information is available from overlapping sensors.

The use of PIR is sensors is not required. Other types of occupancy sensors, may be used instead. In fact, system 100 may be applied to quite different applications than occupancy estimation, e.g., with sensors producing a continuous variable as output that is quantized and a target metric that is to be estimated from the quantized data.

Instead of PIR sensors other types of sensors may be used. If an occupancy sensor is used, it may be a different type of occupancy sensor. An occupancy sensor is arranged to determine occupancy of an area surrounding the occupancy sensor. Several technologies are available for occupancy sensors besides passive infrared occupancy sensors, e.g., ultrasonic occupancy sensors, microwave occupancy sensors, audio detection occupancy sensors, etc. An occupancy sensor may be a motion sensor. Hybrid occupancy sensors combining two or more of these technologies are also possible. For example, in an embodiment an occupancy sensor combines passive infrared (PIR) with ultrasonic detection.

Returning to FIG. 1, shown is a training data storage 110. The training data storage 110 stores multiple unquantized sensor signals. The multiple unquantized sensor signals are obtained from one or more sensors; shown is a sensor 112. For example, a sensor like sensor 650 may be used. In addition, training data storage 110 stores multiple corresponding target metrics. A target metric corresponds to one or to a set of unquantized sensor signals. A sensor signal may be a signal value, but may also be a trace of values, e.g., values over a time interval, e.g., over a number of seconds. The target metrics may be obtained from a target metric input 114. Target metrics may be obtained from sensors that are temporally installed to obtain training data. For example, occupancy metric may be computed from cameras. However, there are several objections to permanently installing cameras in the workplace, ranging from costs to privacy. Alternatively, the target metrics may be obtained from personnel who manually note the target metric, e.g., occupancy and input the target metric at the target metric input 114.

Receiving the unquantized sensor signals and the corresponding target metric may be controlled by a software application that receives these records and stores them in storage 110. The software may run on storage 110, or on a different device, e.g., on a quantization boundary optimization device 150 of system 100.

Quantization boundary optimization device 150 comprises an input configured to receive training data comprising multiple unquantized sensor signals and multiple corresponding target metrics. For example, storage 110 may be part of device 150. For example, device 150 may comprise an input to receive training data, e.g., unquantized sensor signals and corresponding target metrics from storage 110.

Quantization boundary optimization device 150 comprises a processor circuit configured according to an embodiment. Functional aspects and/or units of the processor circuit are described herein. For example, such functional aspects may be implemented in the form of a sequence of computer instructions which are stored at device 150, e.g., in an electronic memory and executed by a microprocessor. Functional aspects and/or units may also or instead be implemented as an electronic hardware circuit.

The processor circuit is configured to obtain a digital representation of a model 120 for predicting the target metric from an unquantized sensor signal. A schematic representation of model 120 is shown in FIG. 1. The model is defined by a number of parameters which include at least the quantization boundaries that are to be optimized. The model comprises a first layer 130 and a second layer 132.

Interestingly, first layer 130 comprises multiple continuous quantization functions (ƒₜ, . . . , ƒ_{Q} that approximate block functions on quantization intervals defined by the quantization boundaries. A block function on a set is the characteristic function of the interval, e.g., the function that is 1 on the set, but zero elsewhere. A quantization interval may be an interval such as (b₁, b₂) or an open-ended interval such as (b₁, ∞) or (∞, b₂). Herein the boundaries b₁<b₂ may be real numbers, or fractions. The intervals may be open (b₁, b₂) or closed [b₁, b₂], or half-open (b₁, b₂] or [b₁, b₂), etc. FIG. 1 shows quantization functions 142, 144 and 146 in model 120.

Model 120 will be trained by device 150 to predict a target metric from (at least) an unquantized sensor signal. Model 120 may receive multiple unquantized sensor signals, and may also receive additional data, e.g., time of day, day of the week, etc.

Model 120 receives the information obtained from the sensors. The signal may be processed both before and after quantization. For example, before quantization, a Fourier operation may be performed, or an average value of the signal may be computed, e.g., over a certain amount of time, etc. The output of this preprocessing may be quantized by the quantization functions. Also after quantization further processing is possible, e.g., to compute average values, e.g. of multiple quantized signals of the same of different sensors, or the number of changes in a period, e.g., a minute, etc. Processing done before quantization would later be performed at the sensor, processing done after quantization would be performed by a prediction back end, and not at the sensor. If gradient descent is used, then preferably the processing after quantization is differentiable with respect to the quantization boundaries.

Second layer 132 may receive additional information. For example, features of additional sensors, e.g., light level, CO2 concentration, temperature, humidity, and door status (open/close); average features or historic features of previous quantized sensor results that show e.g. average value of a sensor's output over a certain period of time. The use of historic features, e.g., the same sensor but 1 second ago, or 0.5 seconds ago, etc., may be modelled by quantizing a copy of the corresponding signal using the same quantized functions. This has the advantage that the quantization bounds are properly optimized also for past signals.

After training the neural network is used to predict the target metric, e.g., the occupancy metric, by measuring the same features, e.g., sensors values, and computing the same computed features, e.g. averages over time, etc., as done for training, inputting the features to the trained neural network and obtaining the output of the evaluated trained neural network.

The unquantized sensor signal, e.g., an unquantized sensor value, e.g., a real number, e.g., a floating-point number, may be received in a model input 121 of model 120. From model input 121 the unquantized sensor signal is forwarded to each of the quantization functions. The outputs of the quantization functions may be regarded as a vector of quantization outputs. The vector will contain values that are near 0 or 1, as the quantization functions approximate a block function, however any value between 0 and 1 is possible. The closer the quantization functions approximate true block functions, the closer the vector will look like a vector with only zero entries and at most one 1 entry. (It may happen that none of the quantization functions produce a one output, e.g., if the input signal does not lie in any of the quantization intervals.)

The second layer 132 comprises a function taking as input the outputs of the multiple continuous quantization functions and generating as output a prediction of the target metric. In addition to the outputs of first layer 130, the second layer may receive additional inputs as noted above.

Device 150 is configured to train model 120 using the training data by iteratively updating the quantization boundaries. For example, device 150 may use an iterative optimization algorithm such as backpropagation and gradient descent.

For example, device 150 may provide model 120 with an unquantized sensor signal 122 as input. The unquantized sensor signal 122 is forwarded by input 121 to the first layer 130 of quantization functions. The quantization functions will produce a vector of quantization results. This vector is in turn used as input to the second layer 132, which will produce a prediction 124 of the target metric. Device 150 compares the prediction 124 produced by model 120 with the expected target metric from storage 110, and generate an update signal 126 of the quantization boundaries. Model 120 is updated according to signal 126. In addition to updating the quantization boundaries, model 120 may also update other parameters of model 120, e.g., of second layer 132.

For example, in an embodiment device 150 comprises a loss function that calculates the difference between the training example from storage 110 and the prediction 124 of model 120, after input signal 122 has been propagated through model 120. Next device 150 may iteratively minimize the loss function by taking steps proportional to the negative of the gradient. For example, device 150 may take the derivative of the loss function with respect to a quantization parameter, and adjust the quantization parameter (alpha) by alpha_new=alpha_old−step_size*derivative. The step_size may be chosen empirically. In an embodiment, the step_size is reduced as training progresses. As model 120 produces better predictions due to the training the quantization functions are optimized intervals that give useful information for the prediction.

The training may enforce that the boundaries remain sorted. That is the training may refuse to move a quantization boundary beyond another boundary. If a backpropagation step would require moving a first quantization boundary past a second quantization boundary, the training may optionally increase, e.g., temporally, the step_size for the second quantization boundary. This will speed up the moving of the second quantization boundary, which may make room for the first quantization boundary. This in turn can speed up the learning process. Alternatively, the second quantization boundary may move along with the first quantization boundary; in this case, it may be advisable to reduce the step_size, otherwise the first and second quantization boundary may start to oscillate, moving each other up and down.

The training device may enforce a minimum distance between quantization boundaries, e.g., based on the measurement accuracy of the sensor.

Before training, the quantization boundaries may be set to arbitrary values, e.g., to uniform quantization boundaries, e.g., equally spaced in the range of the raw sensor signal. If model 120 comprises further trainable parameters, they may be set to random values, e.g., a random value between 0 and 1.

When training is complete, a sensor may be configured with quantization intervals that are taken from the optimized quantization functions. For example, device 150 may be configured to configure a quantization unit 240 of a sensor 200 with quantization boundaries obtained from the trained model.

FIG. 2 schematically shows an example of an embodiment of a system 270 for predicting a target metric which has been configured according to the system 100.

System 270 comprises at least one sensor 200, but more typically will contain multiple sensors 200. Sensor 200 comprises a sensing unit 212. Sensing unit is arranged to sense the environment for some aspect, e.g., according to passive infrared sensing. Sensing unit 212 produces an unquantized sensor signal of the kind used during training, e.g., stored in storage 110 and received from sensor 112.

Sensor 200 comprises a quantization unit 240 configured with quantization boundaries obtained from a trained model. The quantization unit being arranged to select in which quantization interval defined by the quantization boundaries the sensor signal falls and to quantize the sensor signal by a representation of the selected interval, e.g., an encoding of the selected interval. Note that quantization unit 240 does not comprise the quantization functions used in model 120 in FIG. 1. Instead, quantization unit 240 need only contain a list of quantization boundaries that define the quantization intervals. Whereas the quantization functions in FIG. 1 will produce an approximation of a vector that contain only zeroes and at most one 1. The quantization unit 240 will select exactly one of the quantization intervals. For example, sensor 200 may comprise an encoder 248 to encode the selected quantization interval, e.g., as a binary number.

Sensor 200 comprises a transmitter 250 arranged to transmit the quantized sensor signal to the predicting device. For example, if there are n quantization intervals, the selected quantization interval i may be encoded as a binary encoding of the number i. The representation of the selected quantization interval is then sent to a prediction device 220. Prediction device 220 may comprise an input 260 to receive the quantized sensor value. Prediction device contains a copy of the second layer 132 in trained model 120. The received representation of the selected quantization signal may be translated into a vector by setting a vector component to 1 that corresponds to the selected interval which in turn corresponds to the quantization function that was trained to approximate a block function on this quantization interval. The remaining entries in the vector are set to 0. Note that in sensor 200 the quantization may be performed by straightforward comparison operations to compare the value of an unquantized sensor value to the quantization boundaries. Thus, no complicated arithmetic is needed to compute the quantization functions in the sensor 200, this is only needed during training.

The quantization functions are continuous. To ease training, they are preferably also differentiable, at least with respect to the quantization boundaries. In an embodiment, the functions are only piece wise differentiable. A useful choice for the quantization functions are sigmoid functions and/or differences of two sigmoid functions. Other functions may also be used, e.g., approximations of sigmoid functions. Consider for example, “Approximation of the sigmoid function and its derivative using a minimax approach”, by Jason Schlessman (Theses and Dissertations. Paper 752.). For example, instead of approximating a block function using a sigmoid function or a difference between two sigmoid functions, one may also use, e.g., a polynomial approximation of a block function.

In an embodiment, the continuous quantization functions ƒₜ, . . . , ƒ_{Q} are defined by

$${f}_{i} ( x ) = \frac{1}{1 + exp ( - β ( x - {α}_{i} ) )} - \frac{1}{1 + exp ( - β ( x - {α}_{i + 1} ) )} , \\ for 1 < i < Q , and$$

$${f}_{Q} ( x ) = \frac{1}{1 + exp ( - β ( x - {α}_{Q} ) )} or$$

$${f}_{Q} ( x ) = \frac{1}{1 + exp ( - β ( x - {α}_{Q} ) )} - \frac{1}{1 + exp ( - β ( x - {α}_{Q + 1} ) )} , and$$

$${f}_{1} ( x ) = \frac{1}{1 + exp ( - β ( x - {α}_{2} ) )} or$$

$${f}_{1} ( x ) = \frac{1}{1 + exp ( - β ( x - {α}_{1} ) )} - \frac{1}{1 + exp ( - β ( x - {α}_{2} ) )} ,$$

for quantization boundaries αᵢ, with αᵢ<αᵢ₊₁ for 1≤i≤Q+1, wherein β is a parameter for controlling a slope of the quantization functions, and α₁ and α_{Q+1} are optional. The two choices for ƒ₁ and ƒ_{Q} represent the option to have open ended intervals at the end. Two open ended intervals have the advantage that any signal can be quantized. If both the upper and lower interval are not open ended, it may happen that a signal is received that does not fall into any one of the intervals. A sensor may deal with this eventuality by sending an error signal, or a random interval etc. However, if the range of the unquantized signals is known no open ended interval are necessarily needed. In an embodiment, both sides are open-ended, neither side is open ended, or one of the sides is open ended. Whether open-sided ends are used is typically decided by the system designer, and not by the machine learning process.

Note that the quantization intervals are defined by the quantization boundaries. The quantization boundaries may be taken as an order list of numbers, e.g., floating point numbers, the quantization intervals being the interval between the quantization intervals. For example, if αᵢ<αᵢ₊₁ are two quantization boundaries, an interval may be defined by (αᵢ, αᵢ₊₁).

The parameter β defines how closely the quantization functions approximate the block functions. In an embodiment, the parameter β is increased during training, so that the quantization function approximate block functions more closely as training progresses. Increasing β too quickly may slow than the learning process.

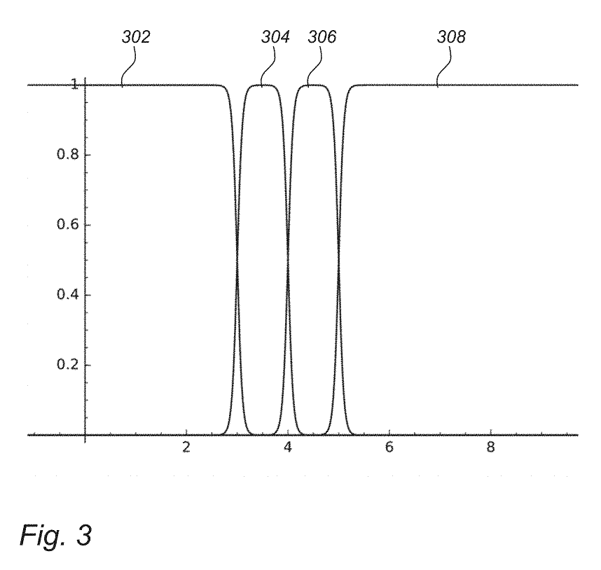

FIG. 3 shows a plot of 4 quantization functions: functions 302, 304,306 and 308. The highest function 308 and the lowest function 302 are open ended, e.g., the corresponding quantization interval runs to plus or minus infinity. The quantization functions 304 and 306 represent a finite interval. In this case the quantization boundaries may be taken as the values 3, 4, and 5 defining intervals that lie between them, e.g., minus infinity to 3, 3 to 4, 4 to 5, and 5 to infinity. If FIG. 3 would represent the end result of a training process, the sensors may now be programmed with the boundaries 3, 4, and 5, without the need of the quantization functions. If the sensor measures a value of say 4.15, it is arranged to find that the measured value lies between the quantization bounds 4 and 5, i.e., the third quantization interval. It may quantize the value 4.15 as the binary string 11.

FIG. 3 was drawn with the following SageMath program:

var(‘x’)
f(x,a)=1/(1+exp(−20*(x−a)))
g=Graphics( )
g+=plot(f(x,5), (−5,10), color=‘black’)
g+=plot(f(x,4)−f(x,5), (−5,10), color=‘black’)
g+=plot(f(x,3)−f(x,4), (−5,10), color=‘black’)
g+=plot(1−f(x,3), (−5,10), color=‘black’)
g.show( )

The approximation of a block function by a quantization function may be defined as the size of the intervals where the absolute difference between the quantization function and the block function is larger than a threshold. For example, if the threshold is set at 0.05, we have that f(x,4)−f(x,5) (as defined above) differs more from the block function than the threshold when x (the unquantized sensor value) is between 3.85 and 4.15 and between 4.85 and 5.15. In other words, the combined size of the intervals where the function f(x,4)−f(x,5) differs more than the threshold from the block function is less than 0.6. By increasing the value of β (which is 20 in the above example), both the threshold and the size of the interval may be decreased. In an embodiment, the difference between the block function for a quantization interval and the quantization function for the quantization interval differs less than 0.05 for intervals having a combined size of 0.6 or less.

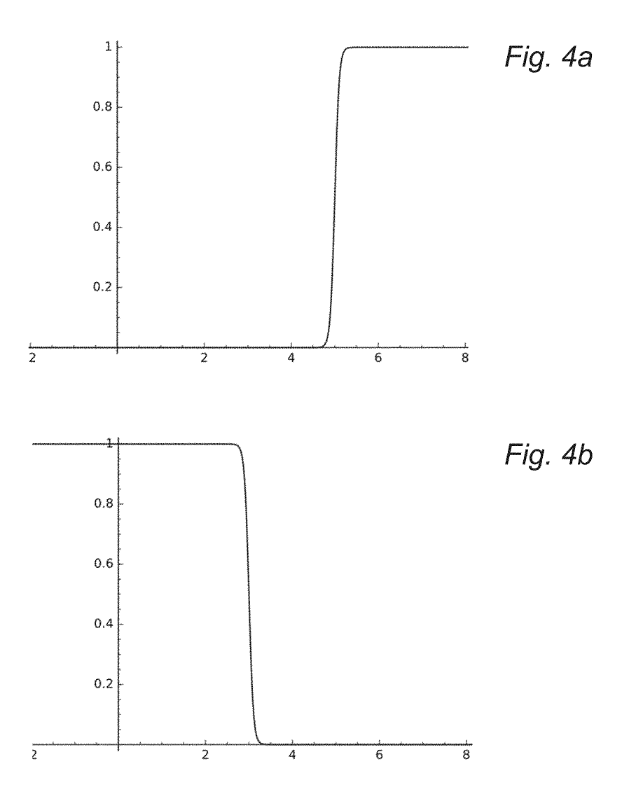

FIGS. 4a-4c schematically show examples of an embodiment of a continuous quantization functions. The quantization functions shown are the same as the quantization functions of FIG. 3, but shown separately. FIGS. 4a and 4b show open ended intervals, and FIG. 4c a finite interval.

Second layer 132 and second layer 232 used in the model 120 while it is trained and in the prediction device 220 after training may be a fixed function. For example, the fixed function may be a fixed weighted sum of the inputs. For example, the fixed function may be a dot product (inner product) of the quantization vector produced by quantization functions 142-146. In second layer 232, the dot product is simply a look-up operations, retrieving a value in response to the received quantization value. For example, in case of 4 levels, the fixed function may assign the values 0, 0.5, 1, and 1.5, to the quantization levels. In this case the training process would model the quantization boundaries to try to match the target metric given this function.

The second layer function may also comprise trainable parameters of its own. For example, instead of a fixed vector in said dot product, the vector may also be trainable. For example, all or some of the entries in the vector may be trained.

More complicated functions than the linear dot-products are possible, but will not always be needed. For example, the second-layer function may be a weighted sum, wherein the weights are trainable.

The second layer may also contain a neural network. Although this may increase the quality of the prediction, it will also significantly increase the amount of needed training data. For the purpose of choosing quantization levels that preserve as much of the information present in the unquantized signal, it is not required that the accuracy of the final trained model 120 is as high as possible, if it is merely the aim that the quantization bounds contribute as much to the final accuracy as possible.

Advantageously, the number of quantization functions is a power of 2. In this case the encoding of the selected interval during quantization uses as much of the bits as possible. In an embodiment, the number of quantization functions is a power of 2 minus 1. The latter has the advantage, that one bit string is unused, which may be used to signal an error. For example, if one of the upper and lower intervals in not open ended, the bit string which is not used to represent a selected interval may be used to signal that an unquantized signal did not fall in any of the intervals. For example, the error bit string may be the all one bit string.

The unquantized sensor signal may be preprocessed before quantization. For example, a Fourier analysis may be performed on the unquantized signal. The energy in for some selected frequency or frequency band may then be quantized as above. This is advantageous in PIR sensors, since people walking by the sensor give a distinct energy in the Fourier spectrum. The energy per frequency can be calculated by using FFT filter banks and then calculating the energy of each bank. Note that multiple quantizations may be obtained from a single raw signal.

For example, the prepressing could take the following forms,

if h(t) is the raw signal coming out of the sensor, you compute |ĥ(ω)|, i.e., the amplitude at a specific predetermined frequency, then quantize this.

some total energy term, e.g., the integral of (h(t))² over some predetermined interval is computed and quantized. The latter could be expressed in terms of Fourier transforms as well.

Generally speaking, one may assume that the output of the sensor is already discretized, e.g., as a value h[x], which is to be quantized.

In an embodiment, the second layer function 132 may depend on multiple sensors. For example, occupancy estimation may be trained for a single sensor, e.g., to optimize the amount of information in the quantized output. But occupancy sensing for rooms or even for a building may depend on the input of multiple sensors. In this case, the second layer 132 may receive multiple quantized sensor signals. Consider for example, the set up shown in FIG. 6. There are 4 sensors cover a room. A much more accurate prediction regarding the number of people present in the room is possible if all sensor data is considered together rather than separate.

To train such a situation, the training data, e.g. training data stored in storage 110, may comprise multiple sets of unquantized sensor signals, a set of unquantized sensor signals being obtained from a corresponding set of multiple sensors. There may be multiple target metrics. Each target metric corresponds to an entire set of unquantized sensor signals. The unquantized sensor signal in a set are each quantized by the quantization functions during training. For example, quantization functions 142-146 may receive as input each unquantized sensor signal in a set of unquantized sensor signals in turn thus obtaining multiple outputs of the multiple continuous quantization functions. The second-layer function may take as input the multiple outputs, e.g., one quantization vector for each unquantized signal in a set.

To quantize the outputs of the sensors, one may take the same quantization boundaries for each sensor. For example, the quantization boundaries of the multiple continuous quantization functions are the same for at least some of the sensors of the multiple sensors. This will speed up learning. On the other hand, different sensors may have different quantization functions. For example, the quantization boundaries of the multiple continuous quantization functions are optimized separately for at least some of the sensors of the multiple sensors. In case of FIG. 6, each of the sensors 650 shown may receive the same quantization boundaries, or they may each receive separately optimized boundaries, etc.

The method of optimizing quantization boundaries may be used to optimize sensors for a particular location. For example, in such a case one may obtain training data from the same sensor as the sensor in which the optimized boundaries will be installed. The sensor will also be installed in the same location during training as during operational use. On the other hand, the optimization method may also be used to optimize a more general purpose sensor. For example, if it is known that a sensor may be used for a particular purpose, e.g., occupancy estimation, it may be sufficient to make sure that the sensor does not throw away relevant information during quantization. In such a case, training data may be obtained from different sensors as the sensors that are configured. If desired a separate model may be trained to estimate occupancy for a building in which the sensors are installed. At that point the quantization boundaries may not be trained anymore, but there would be less of a need to so in any case.

In the various embodiments, the input interfaces of device 150 or prediction device 220 may be selected from various alternatives. For example, the input interface may be a network interface to a local or wide area network, e.g., the Internet, a storage interface to an internal or external data storage, etc.

Training device 150 and prediction device 220 may comprise an electronic storage, which may be implemented as an electronic memory, say a flash memory, or magnetic memory, say hard disk or the like. The storage may comprise multiple discrete memories together making up the storage. The storage may also be a temporary memory, say a RAM. In the case of a temporary storage, the storage contains some means to obtain the data before use, e.g., obtaining them over an optional network connection (not shown).

Typically, the device 150 and 220 each comprise a microprocessor (not separately shown in FIGS. 1 and 2) which executes appropriate software stored at the device 150 and 220; for example, that software may have been downloaded and/or stored in a corresponding memory, e.g., a volatile memory such as RAM or a non-volatile memory such as Flash (not separately shown). The devices 112 and 200 may also be equipped with microprocessors and memories (not separately shown in FIGS. 1 and 2). Alternatively, the devices 150 and 220 may, in whole or in part, be implemented in programmable logic, e.g., as field-programmable gate array (FPGA). Devices 150 and 220 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

In an embodiment, the device 150, 220 and 200 may comprise one or more circuits. The circuits may implement the corresponding functions described herein. The circuits may be a processor circuit and storage circuit, the processor circuit executing instructions represented electronically in the storage circuits.

In an embodiment, device 150 comprise:

an input circuit configured to receive training data comprising multiple unquantized sensor signals and multiple corresponding target metrics, the sensor data being obtained from one or more sensors,

an obtaining circuit configured to obtain a digital representation of a model (120) for predicting the target metric from an unquantized sensor signal, the model being defined by at least the quantization boundaries, the model comprising a first layer of multiple continuous quantization functions (ƒ₁, . . . , ƒ_{Q}), the quantization functions receiving as input an unquantized sensor signal and approximate block functions on quantization intervals defined by the quantization boundaries, and a second layer comprising a function taking as input the output of the multiple continuous quantization functions and generating as output a prediction of the target metric,

a training circuit configured train to the model using the training data by iteratively updating the quantization boundaries, and

a configuring circuit configured to configure a quantization unit (240) of a sensor with quantization boundaries obtained from the trained model, the quantization unit being arranged to select in which quantization interval defined by the quantization boundaries a sensor signal falls and to quantize the sensor signal by a representation of the selected interval.

In an embodiment, device 200 comprises:

sensing circuit configured to generate an unquantized sensor signal,

a quantization circuit configured with quantization boundaries obtained from a trained model, the quantization unit being arranged to select in which quantization interval defined by the quantization boundaries the sensor signal falls and to quantize the sensor signal by a representation of the selected interval, and

a transmitter circuit arranged to transmit the quantized sensor signal to the predicting device,

In an embodiment, predicting device 220 comprises:

an input circuit configured to receive quantized sensors signals from the multiple sensors, and

an evaluation circuit configured to evaluate a second layer comprising a function taking as input the received quantized sensor signals, and generating as output a prediction of the target metric.

A processor circuit may be implemented in a distributed fashion, e.g., as multiple sub-processor circuits. A processor circuit may implement one or more of the circuit mentioned above. A storage may be distributed over multiple distributed sub-storages. Part or all of the memory may be an electronic memory, magnetic memory, etc. For example, the storage may have volatile and a non-volatile part. Part of the storage may be read-only. The circuits may also be, FPGA, ASIC or the like.

The invention may be applied in a connected lighting system with multiple PIR occupancy sensors delivering occupancy data to a backend system. PIR occupancy sensors are low-cost motion sensors commonly used for lighting control based on binary detection. With a PIR sensor in each luminaire, one may obtain advanced occupancy information such as approximate people count by processing data from such PIR sensor grids. Selecting quantization levels of feature signals, e.g. amplitude, frequencies and so on, of such sensors is done using machine learning.

Smart lighting systems with multiple luminaires and sensors are witnessing a steady growth. Such systems use multi-modal sensor inputs, e.g. in the form of occupancy and light measurements, to control the light output of the luminaires and adapt artificial lighting conditions to prevalent environmental conditions. With the spatial granularity that such a sensor deployment comes in the context of lighting systems, there is potential to use sensor data to learn about the operating environment. One such aspect is related to occupancy. There is increased interest in learning about the occupancy environment beyond basic presence. Advanced sensor technologies like cameras may be used for this purpose. However, there is increased cost in this approach.

Given that low-cost PIR sensors are being collocated in each luminaire of a smart lighting system, it would be advantageous to extract an approximate count of people using data from a PIR sensor grid. The selection of the quantization levels of feature signals, e.g. amplitude, frequencies and so on, from PIR occupancy sensor may be automated, such that approximate people counting information may be derived within a desirable range of accuracy.

In an embodiment, a lighting system comprises multiple PIR occupancy sensors, with sensor data collected at a data analytics engine. During a training phase, each PIR occupancy sensor transmits its raw feature signal, e.g. amplitude, frequencies and so on, to the data analytics engine. Using machine learning algorithms, e.g. forward neural networks, the data analytics engine selects a limited set of quantization levels of the feature signal of each PIR occupancy sensor and trains a people counting algorithm based on the quantized signals.

After training, the data analytics engine transmits to each PIR occupancy sensor the corresponding quantization levels. During an operational phase, each PIR occupancy sensor quantizes its raw feature signal and transmits the values to the data analytics engine using the quantization levels. The data analytics engine can use the quantized signal to estimate the people count instead of the raw signal. Overhead in sending the raw signal is reduced, but on the other hand the choice of the quantization levels was made by the machine learning algorithm which reduces the loss of information.

During training phase, the data analytics engine collects the raw feature signal data from all sensors into a database. For a given occupancy sensor, the quantization of raw feature signal x^{(t)} into a pre-defined number of levels Q, {y_{q}^{(t)}, q=1, . . . , Q}, can be modelled using quantization functions. The quantized signals {y_{q}^{(t)}, q=1, . . . , Q} from multiple PIR occupancy sensors are used together with a second layer function g( ) to estimate the people count. Function g receives the quantized signals of one or more sensors form the quantization functions.

In an embodiment, the algorithm g( ) is predetermined. For example, the function g may be a correlation of the quantized feature signals, or the number of sensors at quantization level q or any linear combination of the quantized feature signals, etc. In this case, the data analytics engine only has to determine parameters {α_{q}, q=1, . . . , Q} of the quantization functions {ƒ_{q}{⋅}, q=1, . . . , Q}. A parameter like β may be given. These parameters are found using known algorithms such as back propagation.

In another embodiment, the algorithm g( ) is itself a function to be trained, e.g., using support vector regression, wherein g( )=Σₛₑₙₛₒᵣₛ(Σ_{q}c_{q}y_{q}) where c_{q} are weights to be learned. In this case, the data analytics engine determines simultaneously parameters {α_{g}, q=1, . . . , Q} of functions {ƒ_{q}( ), q=1, . . . , Q}, for a given β; and parameters of function g. These parameters may be found using known algorithms such as as back propagation.

After training, the quantization sets (e.g. parameters {α_{q}, q=1, . . . , Q}) are transmitted to each corresponding PIR occupancy sensor. During operational phase, each PIR occupancy sensor quantizes its feature signal using the trained set and transmits the quantized values to the data analytics engine. The quantized signals {y_{q}^{(t)}, q=1, . . . , Q} from multiple PIR occupancy sensors, are input by the data analytics engine to the trained algorithm g to estimate the people count.

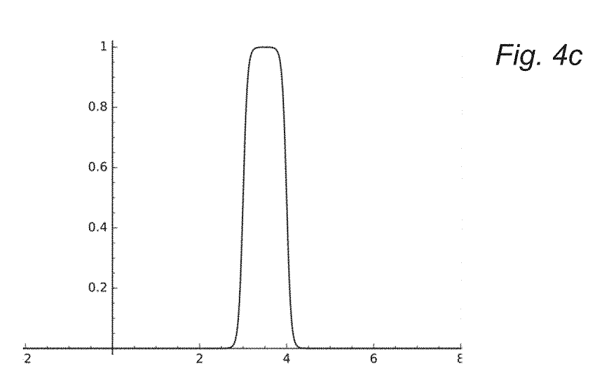

FIG. 5a schematically shows an example of an embodiment of a computer-implemented method 500 of optimizing non-uniform quantization boundaries for a quantization unit of a sensor. Method 500 may be executed by a training device 150 in a system such as system 100. Method 500 comprises:

obtaining (510) training data (110) comprising multiple unquantized sensor signals and multiple corresponding target metrics, the sensor data being obtained from one or more sensors (112),

obtaining (520) a digital representation of a model (120) for predicting the target metric (124) from an unquantized sensor signal (122), the model being defined by at least the quantization boundaries, the model comprising:
a first layer (130) of multiple continuous quantization functions (142, 144, 146; ƒ₁, . . . , ƒ_{Q}, the quantization functions approximating block functions on quantization intervals defined by the quantization boundaries and receiving as input an unquantized sensor signal, and
a second layer (132) comprising a function taking as input the output of the multiple continuous quantization functions and generating as output a prediction of the target metric, and

training (530) the model using the training data by iteratively updating (126) the quantization boundaries,

configuring (540) a quantization unit (240) of a sensor (200) with quantization boundaries obtained from the trained model, the quantization unit being arranged to select in which quantization interval, defined by the quantization boundaries, a sensor signal falls and to quantize the sensor signal by a representation of the selected interval.

FIG. 5b schematically shows an example of an embodiment of an electronic method 600 for predicting a target metric. Method 600 may be executed by a system such as system 270 comprising one or more sensors such as sensor 200 and a prediction device such as prediction device 220. Method 600 comprises:

generating (610) unquantized sensor signals at multiple sensors,

quantizing (620) the unquantized sensor signals using quantization boundaries obtained from a trained model, the quantization comprising selecting in which quantization interval defined by the quantization boundaries the sensor signal falls and to quantize the sensor signal by a representation of the selected interval,

transmitting (630) the quantized sensor signal to a predicting device,

evaluating (640) a second layer comprising a function taking as input the transmitted quantized sensor signals, and generating as output a prediction of the target metric.

Many different ways of executing methods 500 and 600 are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to the invention may be executed using software, which comprises instructions for causing a processor system to perform methods 500 and 600. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

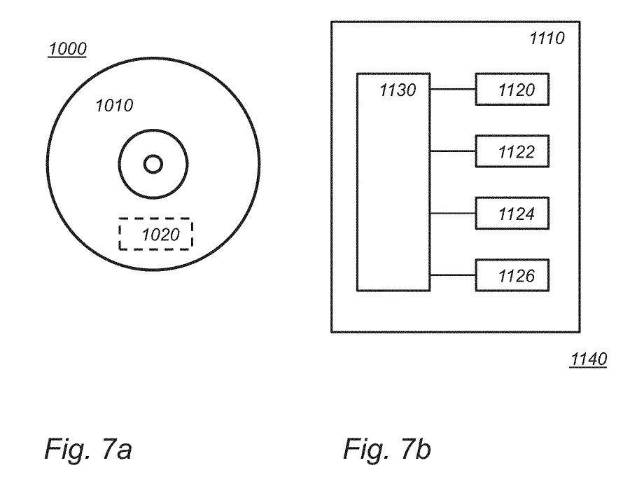

FIG. 7a shows a computer readable medium 1000 having a writable part 1010 comprising a computer program 1020, the computer program 1020 comprising instructions for causing a processor system to perform a method of optimizing non-uniform quantization boundaries for a quantization unit of a sensor or a method for predicting a target metric, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said a method of optimizing non-uniform quantization boundaries for a quantization unit of a sensor or a method for predicting a target metric.

FIG. 7b shows in a schematic representation of a processor system 1140 according to an embodiment. The processor system comprises one or more integrated circuits 1110. The architecture of the one or more integrated circuits 1110 is schematically shown in FIG. 7b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the training device 150 or the predicting device 220 may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. The processor circuit in a sensor may be an ARM Cortex M0.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

1. A computer-implemented method of optimizing non-uniform quantization boundaries for a quantization unit of a sensor,
obtaining training data comprising multiple unquantized sensor signals and multiple corresponding target metrics, the sensor data being obtained from one or more sensors,
obtaining a digital representation of a model for predicting the target metric from an unquantized sensor signal, the model being defined by at least the quantization boundaries, the model comprising:
a first layer of multiple continuous quantization functions, the quantization functions approximating block functions on quantization intervals defined by the quantization boundaries and receiving as input an unquantized sensor signal, and
a second layer comprising a function taking as input the output of the multiple continuous quantization functions and generating as output a prediction of the target metric, and
training the model using the training data by iteratively updating the quantization boundaries, wherein a quantization unit of a sensor may be configured with the quantization boundaries obtained from the trained model,
wherein the sensor is an occupancy sensor and wherein the target metric is an occupancy metric.

2. A method as in claim 1, comprising:
configuring a quantization unit of a sensor with quantization boundaries obtained from the trained model, the quantization unit being arranged to select in which quantization interval, defined by the quantization boundaries, a sensor signal falls and to quantize the sensor signal by a representation of the selected interval.

3. A method as in claim 1, wherein the continuous quantization functions are sigmoid functions and/or differences of two sigmoid functions.

4. A method as in claim 3, wherein the continuous quantization functions ƒ₁, . . . , ƒ_{Q} are defined by
$${f}_{i} ( x ) = \frac{1}{1 + exp ( - β ( x - {α}_{i} ) )} - \frac{1}{1 + exp ( - β ( x - {α}_{i + 1} ) )} , \\ for 1 < i < Q , and$$
$${f}_{Q} ( x ) = \frac{1}{1 + exp ( - β ( x - {α}_{Q} ) )} or$$
$${f}_{Q} ( x ) = \frac{1}{1 + exp ( - β ( x - {α}_{Q} ) )} - \frac{1}{1 + exp ( - β ( x - {α}_{Q + 1} ) )} , and$$
$${f}_{1} ( x ) = \frac{1}{1 + exp ( - β ( x - {α}_{2} ) )} or$$
$${f}_{1} ( x ) = \frac{1}{1 + exp ( - β ( x - {α}_{1} ) )} - \frac{1}{1 + exp ( - β ( x - {α}_{2} ) )} ,$$
for quantization boundaries αᵢ, with αᵢ<αᵢ₌₁ for 1≤i≤Q+1, wherein β is a parameter for controlling a slope of the quantization functions, and α₁ and α_{Q+1} are optional.

5. A method as in claim 1, wherein the sensors are passive infrared (PIR) sensors.

6. A method as in claim 1, wherein the occupancy metric is a people count or a people density.

7. A method as in claim 1, wherein
the training data comprises multiple sets of unquantized sensor signals, a set of unquantized sensor signals being obtained from a corresponding set of multiple sensors,
the quantization functions receiving as input each unquantized sensor signal in a set of unquantized sensor signals obtaining multiple outputs of the multiple continuous quantization functions, the second-layer function taking as input the multiple outputs, wherein
the quantization boundaries of the multiple continuous quantization functions are the same for at least some of the sensors of the multiple sensors, or
the quantization boundaries of the multiple continuous quantization functions are optimized separately for at least some of the sensors of the multiple sensors.

8. A method as in claim 7, wherein at least some of the sensors of the multiple sensors cover an overlapping area.

9. A method as in claim 1, wherein
the second-layer function is a fixed function, or
the second-layer function depends on parameters that are trainable together with the quantization boundaries.

10. A method as in claim 9, wherein the second-layer function is a weighted sum, said weights being trainable.

11. A method as in claim 1 wherein the number of quantization functions is a power of 2, or a power of 2 minus 1.

12. A method as in claim 1, wherein the sensor signal is preprocessed, e.g., by applying a Fourier analysis and computing an energy for a frequency.

13. A quantization boundary optimization device for a quantization unit of a sensor, the optimization device comprising:
an input configured to receive training data comprising multiple unquantized sensor signals and multiple corresponding target metrics, the sensor data being obtained from one or more sensors,
a processor circuit configured to:
obtaining a digital representation of a model for predicting the target metric from an unquantized sensor signal, the model being defined by at least the quantization boundaries, the model comprising a first layer of multiple continuous quantization functions, the quantization functions receiving as input an unquantized sensor signal and approximate block functions on quantization intervals defined by the quantization boundaries, and a second layer comprising a function taking as input the output of the multiple continuous quantization functions and generating as output a prediction of the target metric,
training the model using the training data by iteratively updating the quantization boundaries,
configuring a quantization unit of a sensor with quantization boundaries obtained from the trained model, the quantization unit being arranged to select in which quantization interval defined by the quantization boundaries a sensor signal falls and to quantize the sensor signal by a representation of the selected interval,
wherein the sensor is an occupancy sensor and wherein the target metric is an occupancy metric.

14. A system for predicting a target metric, the system comprising at least one sensor and a predicting device, wherein
the sensor comprises:
a sensing unit configured to generate an unquantized sensor signal,
a quantization unit configured with quantization boundaries obtained from a trained model, the quantization unit being arranged to select in which quantization interval defined by the quantization boundaries the sensor signal falls and to quantize the sensor signal by a representation of the selected interval,
a transmitter arranged to transmit the quantized sensor signal to the predicting device, and
the predicting device comprises:
an input configured to receive quantized sensors signals from the multiple sensors,
a processor circuit configured to evaluate a second layer comprising a function taking as input the received quantized sensor signals, and generating as output a prediction of the target metric,
wherein the sensor is an occupancy sensor and wherein the target metric is an occupancy metric.

15. (canceled)

16. A computer readable medium comprising transitory or non-transitory data representing instructions to cause a processor system to perform the method according to claim 1.
